(19) United States
(12) Patent Application Publication
(10) Pub. No.: US 2023/0403321 A1
(43) Pub. Date: Dec. 14, 2023

(54) METHOD OF CONSTRUCTIING COMMUNITY-ORIENTED COMMUNICATION GROUPS

(71) Applicant: Charles Lap San CHAN, Taipei (TW)

(72) Inventor: Charles Lap San CHAN, Taipei (TW)

(21) Appl. No.: 18/328,956

(22) Filed: Jun. 5, 2023

(30) Foreign Application Priority Data
Jun. 14, 2022 (TW) 111121999

(51) Int. Cl. H04L 67/104; H04L 51/04

(52) U.S. Cl. CPC H04L 67/1044; H04L 51/04

(57) ABSTRACT

In a method of constructing community-oriented communication groups, a user can rapidly construct a new communication group and subgroups included in the new communication group according to requirements. Alternatively, the user combines two existing communication groups into a new communication group. In the new communication group constructed by the user, other members of the new communication group other than the user cannot detect some members of the subgroup. In this way, other members of the new communication group will not feel that too many members in the group cause trouble and some members in the subgroup will have the opportunity to help users reply to the messages in the new communication group.

This application claims priority for TW patent application no. 111121999 filed on 14 Jun. 2022, the content of which is incorporated by reference in its entirely.

### BACKGROUND OF THE INVENTION

### Field of the Invention

The present invention relates to a method of constructing community-oriented communication groups, particularly to a communication method that can construct a communication group including subgroups and hide some members of the subgroup.

### Description of the Related Art

In the modern life of personal portable electronic devices such as notebook computers, tablet computers, smart phones, etc., which are widely used, it is quite common to use communication software to keep in touch with family members, friends, colleagues or clients.

When using communication software, in addition to the one-to-one communication with the contact object, another common way is to construct a communication group with the user himself and several other contact objects, so that they can simultaneously communicate with each other for discussion

However, constructing a communication group and adding a plurality of persons to the communication group may not meet everyone's expectation in practical application. For example, client A of company A may contact business manager B of company B on a specific business project. If client A has any questions, he hopes to directly contact business manager B without having to face other persons. Nevertheless, there may be the members of business manager B's business team in the company's organization who can support and assist business manager B in dealing with all the problems of company A's client A, C company's client C, D company's client D, etc.

In order to convey the question of client A to the members of business manager B's business group for processing, business manager B may have to frequently check whether client A has raised new questions in the communication software and need to forward the question to the communication group of his business team. Thus, the members of the communication group can view the messages in the communication group.

If a member of the communication group of the business team sends a message to reply to the question, business manager B also needs to forward the message to client A. During this process, the message is repeatedly forwarded, which will cause considerable trouble to business manager B. Accordingly, how to efficiently forward messages between different communication groups and allow only specific members to view and reply to messages according to users' requirement has become a research direction for those skilled in the art.

### SUMMARY OF THE INVENTION

The primary objective of the present invention is to provide a method of constructing community-oriented communication groups, which constructs a communication group including subgroups.

Another objective of the present invention is to provide a method of constructing community-oriented communication groups, which hides some members of a subgroup corresponding to the specific members of a communication group.

In order to achieve the foregoing objectives, the present invention provides a method of constructing community-oriented communication groups, which is applied to an environment including a messaging server, a user device, at least one client device, and at least one assistant device that are installed with software, wherein the user device, the at least one client device, and the at least one assistant device are electrically connected to the messaging server. The method of constructing community-oriented communication groups includes:

Step (A): by a user, operating the user device to execute a group setting program to edit group setting data, wherein the group setting data includes a workgroup and a virtual subgroup included in the workgroup;

Step (B): sending the group setting data to the messaging server; and

Step (C): by the messaging server, respectively providing group communication interfaces for the user device, the at least one client device, and the at least one assistant device based on the group setting data, wherein the group communication interface of the at least one client device displays the workgroup, the group communication interfaces of the user device and the at least one assistant device display one or a combination of the workgroup and the virtual subgroup.

The features, advantages, or similar expressions mentioned in the specification do not mean that all the features and advantages that can be realized by the present invention should be in any single specific embodiment of the present invention. Rather, it should be understood that the expression of related features and advantages means that the specific features, advantages, or characteristics described in conjunction with specific embodiments are included in at least one specific embodiment of the present invention. Therefore, the discussion of features and advantages, and similar expressions in the specification is related to the same specific embodiment, but it is not necessary.

Below, the embodiments are described in detail in cooperation with the drawings to make easily understood the technical contents, characteristics and accomplishments of the present invention.

### BRIEF DESCRIPTION OF THE DRAWINGS

FIG. 1 is a schematic diagram illustrating a system that can perform a method of constructing community-oriented communication groups according to a preferred embodiment of the present invention;

FIG. 2 is a flowchart of a method of constructing community-oriented communication groups according to a preferred embodiment of the present invention;

FIG. 3 is a schematic diagram illustrating group setting data edited by a user device according to a preferred embodiment of the present invention; and

FIGS. 4A-4F are schematic diagrams illustrating the group communication interfaces of devices of members according to a preferred embodiment of the present invention.

### DETAILED DESCRIPTION OF THE INVENTION

In order to make the description of the present disclosure more detailed and complete, the following provides an illustrative description for the implementation aspects and specific embodiments of the present invention; but this is not the only way to implement or use specific embodiments of the present invention. The implementations cover the characteristics of specific embodiments and the steps and sequences of the method used to construct and operate these specific embodiments. However, other specific embodiments can also be used to achieve the same or equal functions and sequence of steps.

It should be noted that, unless otherwise specified, all functions described herein may be implemented in hardware or used as software instructions that enable a computer to perform predetermined operations, wherein the software instructions are implemented in a computer-readable storage media, such as a random-access memory (RAM), a hard disk drive, a flash memory, or other types of a computer-readable storage media known to those skilled in the art. In some embodiments, the predetermined operations of the computer are performed by a processor, such as a computer, or performed by program codes such as computer program codes or program codes of software or firmware. In some embodiments, the predetermined operations of the computer are performed by integrated circuits encoded to perform these functions. Furthermore, it should be understood that various operations described herein as being performed by a user may be performed manually by the user, or may be automatically performed with or without instructions provided by the user.

The present invention provides a method of constructing community-oriented communication groups. In the method, a user can rapidly construct a new communication group and subgroups included in the new communication group according to requirements. Alternatively, the user combines two existing communication groups into a new communication group. In the new communication group constructed by the user, other members of the new communication group other than the user cannot detect some members of the subgroup. In this way, other members of the new communication group will not feel that too many members in the group cause trouble and some members in the subgroup will have the opportunity to help users reply to the messages in the new communication group.

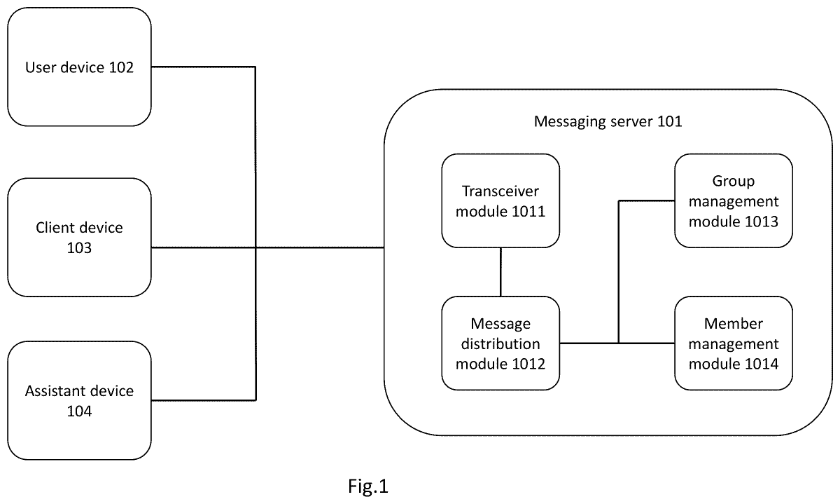

Please refer to FIG. 1. FIG. 1 is a schematic diagram illustrating a system that can perform a method of constructing community-oriented communication groups according to a preferred embodiment of the present invention. The use of each device and the functional units in the system will be described first, and the operation process of the system will be further described later. In FIG. 1, the system includes an environment including a messaging server 101, a user device 102, a client device 103, and an assistant device 104 that are installed with software.

The user device 102, the client device 103, and the assistant device 104 are electrically connected to the messaging server 101 via a network and are independent electronic devices, such as mobile devices, notebook computers, tablet computers, intelligent phones, etc.

The messaging server 101 includes a transceiver module 1011, a message distribution module 1012, a group management module 1013, and a member management module 1014. The transceiver module 1011 can receive group setting data, receive messages, or send messages. The message distribution module 1012 can distribute the message to the correct receiving member according to the group setting data. The group management module 1013 stores the group setting data and the data of each communication group. For example, the data stored by the group management module 1013 includes, but not limited to, group names, group categories, group members, the permissions of group members, etc. The member management module 1014 stores the information of each member. The information includes, but not limited to, member accounts, member devices, the Internet Protocol (IP) addresses of member devices, etc.

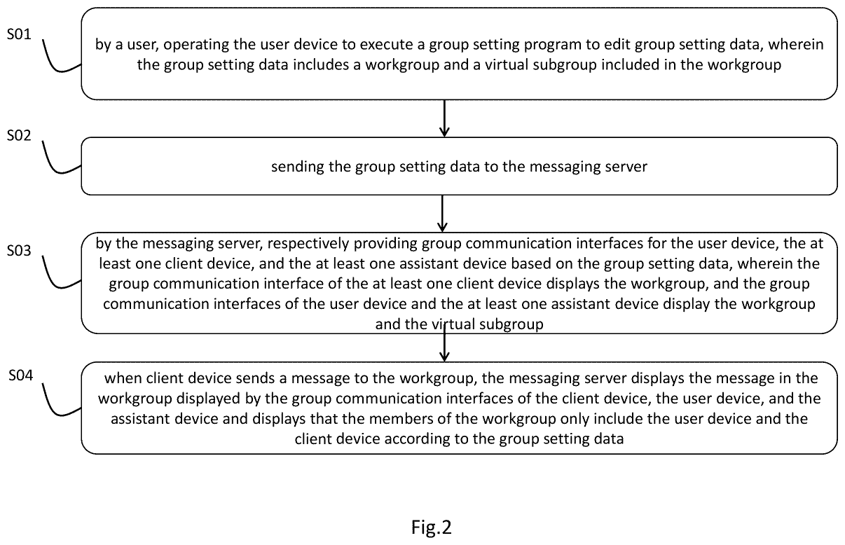

Please refer to FIG. 2. FIG. 2 is a flowchart of a method of constructing community-oriented communication groups according to a preferred embodiment of the present invention. For the following description, please refer to FIG. 1 and FIG. 2 simultaneously. The use of each device will be specifically described in the flowchart below. It should be understood that the order of the steps in the flowchart can be changed according to different requirements and that certain steps can be omitted.

Firstly, in Step S01, a user operates the user device 102 to execute a group setting program to edit group setting data. The group setting data includes a workgroup and a virtual subgroup included in the workgroup. For the sake of explanation, only a combination of the user device 102, the client device 103, and the assistant device 104 is used for explanation in the embodiment of FIG. 1 and FIG. 2, but it should be understood that other embodiments of the present invention can include multiple client devices or multiple assistant devices. The embodiment of the present invention is not limited to a virtual subgroup included in the workgroup.

When the user operates the user device 102 to execute the group setting program, a user interface can be provided by the communication software installed in the user device 102. The user interface can display the contact list and the communication group list of the user. The user can edit the group setting data according to the contact list and the communication group list. Wherein, the group setting data includes a workgroup and a virtual subgroup included in the workgroup. The workgroup and the virtual subgroup may be constructed by the user when editing the group setting data. Alternatively, the user selects two constructed groups in the communication group list as the workgroup and the virtual subgroup respectively.

In an embodiment of the present invention, the members of the workgroup include, for example, the user device 102 and the client device 103. The members of the virtual subgroup include the user device 102 and the assistant device 104. It should be understood that, in other embodiments of the present invention, the members of the workgroup are not limited to the user device 102 and the client device 103. The members of the workgroup may include more client devices. In addition, in other embodiments of the present invention, the workgroup is not limited to including one virtual subgroup, but may include multiple virtual subgroups. The members of each virtual subgroup may be partially repeated or completely different.

In an embodiment of the present invention, when executing the group setting program, the user can also edit the message receiving/sending permission of the assistant device 104. Wherein, the message receiving/sending permission includes: whether to receive messages from the workgroup and whether to send messages to the workgroup. For example, assume that the user edits the message receiving/sending permission of the assistant device 104 and allows it to receive messages from the workgroup. When any message is generated in the workgroup (e.g., the user device 102 or the client device 103 has sent a message), the assistant device 104 can receive the message from the workgroup. On the contrary, assume that the message receiving/sending permission of the assistant device 104 is not allowed to receive the message from the workgroup. When any message is generated in the workgroup (e.g., the user device 102 or the client device 103 has sent a message), the assistant device 104 will not receive the message from the workgroup.

For another example, if the user edits the message receiving/sending permission of the assistant device 104 and allows it to send messages to the workgroup, the assistant device 104 can send messages to the workgroup. For example, in one embodiment, in order to assist the user device 102, the assistant device 104 replies to the questions raised by the client device 103 in the workgroup. On the contrary, if the user edits the message receiving/sending permission of the assistant device 104 and forbids it to send messages to the workgroup, the assistant device 104 cannot send messages to the workgroup.

In addition, in another embodiment of the present invention, when executing the group setting program, the user can also edit the proxy authority of the assistant device 104. Wherein, the proxy authority is set to display in the workgroup of the client device 103 that a message is sent by the user device 102 when the assistant device 104 sends the message to a workgroup. In this way, in the workgroup of the client device 103, only the client device 103 and the user device 102 are in a conversation, and the assistant device 104 will not appear in the conversation. Thus, it does not cause trouble to the client that operates the client device 103. Additionally, in one embodiment of the present invention, the workgroup displayed by the group communication interfaces of the user device 102 and the assistant device 104 is additionally marked in order to facilitate the users of the user device 102 and the assistant device 104 to identify the messages sent to the workgroup by the assistant device 104 in the name of the user device 102.

In Step S02, the group setting data are sent to the messaging server 101. In one embodiment of the present invention, after the user operates the user device 102 to edit the group setting data, the user device 102 sends the group setting data to the transceiver module 1011 of the messaging server 101, and then the messaging server 101 stores the group setting data in the group management module 1013.

In Step S03, the messaging server 101 respectively provides group communication interfaces for the user device 102, the client device 103, and the assistant device 104 based on the group setting data. The group communication interface of the client device 103 displays the workgroup. The group communication interfaces of the user device 102 and the assistant device 104 display one or a combination of the workgroup and the virtual subgroup.

In one embodiment of the present invention, the communication software installed in the user device 102, the client device 103 and the assistant device 104 can all provide a user interface. The user interface can employ the group communication interface provided by the messaging server 101 based on the group setting data. Wherein, the message distribution module 1012 in the messaging server 101 will access the group setting data stored by the group management module 1013. Then, the members (i.e., the user device 102 and the client device 103) included in the workgroup, the virtual subgroups included in the workgroup, and the members (i.e., the user device 102 and the assistant device 104) included in the virtual subgroup are obtained according to the group setting data. The message distribution module 1012 then accesses the information (such as the IP addresses of the user device 102, the client device 103 and the assistant device 104) of the members in the member management module 1014 according to the members included in the group setting data. Finally, the message distribution module 1012 sends the group communication interface to the user device 102, the client device 103 and the assistant device 104 respectively through the transceiver module 1011 and the network.

It should be understood that one of the objectives of the present invention is to include subgroups (such as virtual subgroups) in a communication group (such as a workgroup), and to hide some members of the subgroup corresponding to the specific members of the communication group, so that the user device 102 can obtain assistance from the assistant device 104 in the subgroup, so as to serve the client device 103. The client device 103 that is in the same communication group as the user device 102 will only see the user device 102 rather than the assistant device 104 in the communication group. As a result, the user of the client device 103 does not feel troubled due to the presence of unknown members in the communication group.

In one embodiment of the present invention, the flowchart of the method in FIG. 2 further includes Step S04. In Step S04, when the client device 103 sends a message to the workgroup, the messaging server 101 displays the message in the workgroup displayed by the group communication interfaces of the client device 103, the user device 102, and the assistant device 104 and displays that members of the workgroup only include the user device 102 and the client device 103 according to the group setting data.

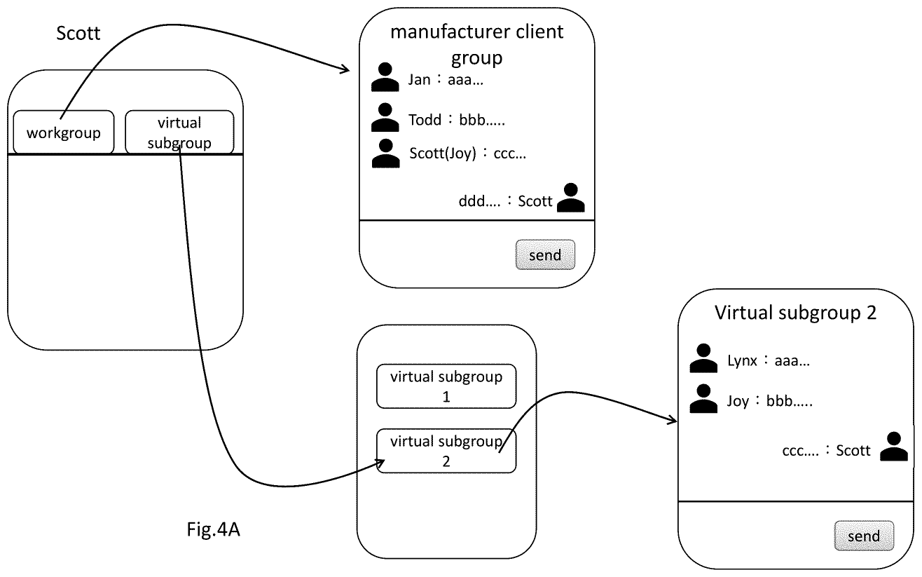

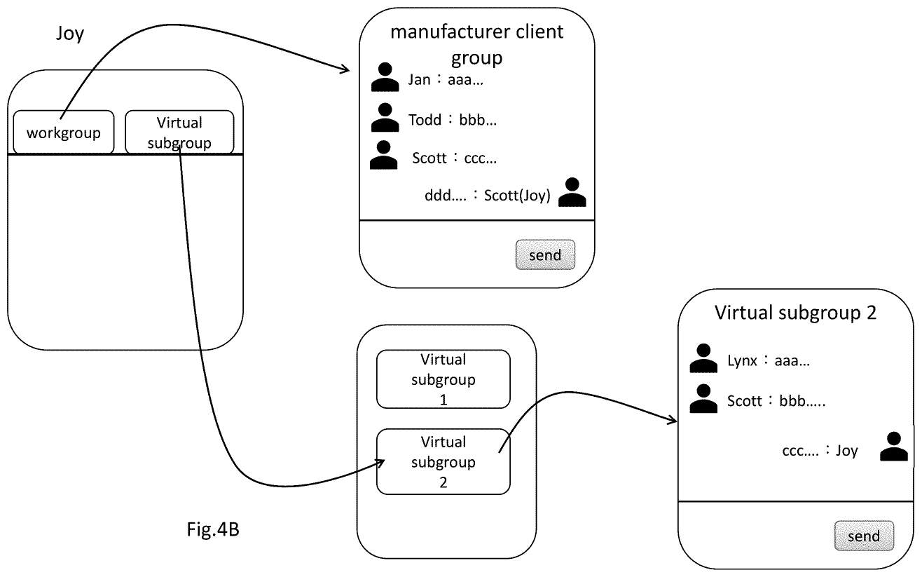

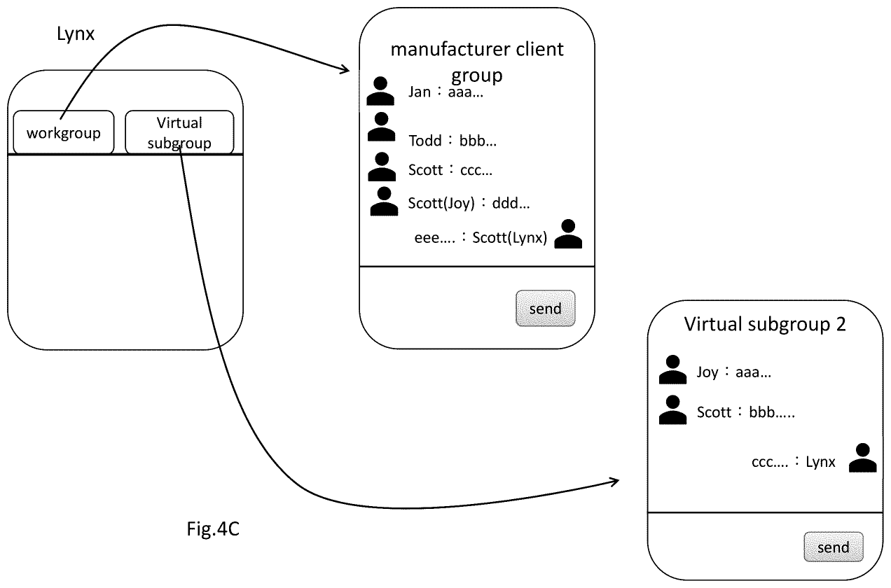

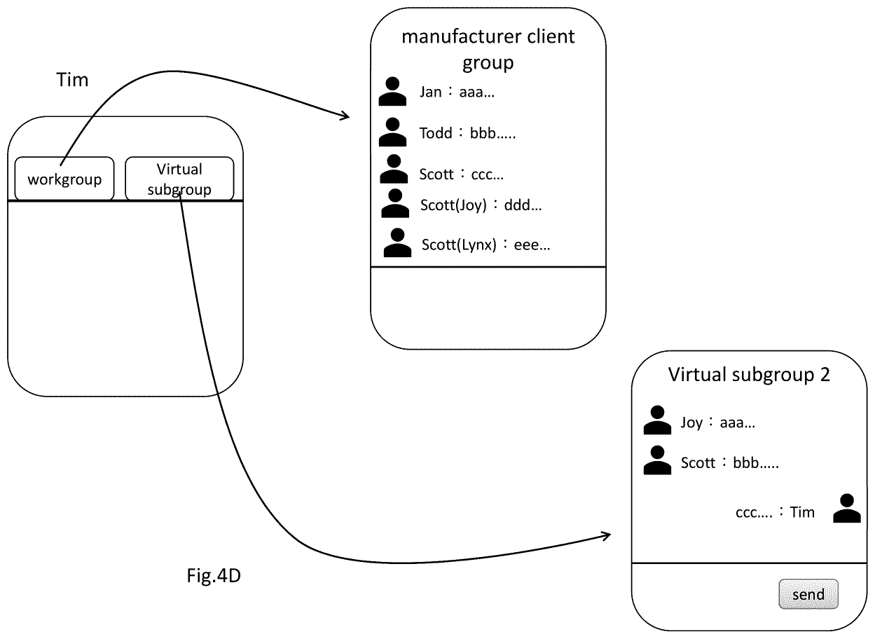

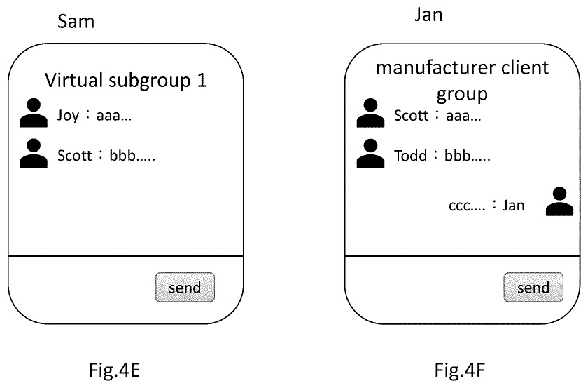

In Step S04, the message distribution module 1012 in the messaging server 101 will access the group setting data stored by the group management module 1013, and then obtain the members (i.e., the user device 102 and the client device 103) included in the workgroup, the virtual subgroups included in the workgroup, and the members (i.e., the user device 102 and the assistant device 104) included in the virtual subgroup according to the group setting data. According to the members included in the group setting data, the message distribution module 1012 accesses the information (such as the IP addresses of the user device 102, the client device 103, and the assistant device 104) of the members in the member management module 1014, and checks the message receiving/sending permission of the assistant device 104 (e.g., whether to receive the message from the workgroup). Finally, the message distribution module 1012 sends the message to the user device 102, the client device 103 and the assistant device 104 respectively through the transceiver module 1011 and the network, and displays the message in the workgroup displayed by the group communication interfaces of the client device 103, the user device 102, and the assistant device 104. The members displayed by the workgroup of the client device 103 only include the user device 102 and the client device 103, but the members displayed by the workgroup of the user device 102 and the assistant device 104 include the client device 103, the user device 102, and the assistant device 104 (please refer to the description in FIG. 4) that is additionally marked to assist in sending messages.

In another embodiment of the present invention, the flowchart of the method in FIG. 2 further includes another Step S04 (not illustrated). When the assistant device 104 sends a message to the workgroup, the messaging server 101 displays the message in the workgroup displayed by the group communication interfaces of the client device 103, the user device 102, and the assistant device 104 and displays the message in the workgroup of the client device 103 that the message is sent by the user device 102 according to the group setting data. The workgroup of the user device 102 and the assistant device 104 additionally marked that the assistant device 104 assists the user device 102 in sending the message.

In Step S04 of the embodiment, the message distribution module 1012 in the messaging server 101 will access the group setting data stored by the group management module 1013 in the foregoing manner, and then obtain members included in the workgroup and the virtual subgroup according to the group setting data. The message distribution module 1012 then accesses the information (such as the IP addresses of the user device 102, the client device 103, and the assistant device 104) of the members in the member management module 1014, and checks the message receiving/sending permission and the proxy authority (e.g., whether to send a message to the workgroup and whether to display that the message is sent by the user device 102) of the assistant device 104. Finally, the message distribution module 1012 sends the message to the user device 102, the client device 103 and the assistant device 104 respectively through the transceiver module 1011 and the network, displays the message in the workgroup displayed by the group communication interfaces of the client device 103, the user device 102, and the assistant device 104, and displays in the workgroup of the client device 103 that the message is sent by the user device 102. The workgroup of the user device 102 and the assistant device 104 additionally marked that the assistant device 104 assists the user device 102 in sending the message.

In yet another embodiment of the present invention, the flowchart of the method in FIG. 2 further includes yet another Step S04 (not illustrated). When the user device 102 or the assistant device 104 sends a message to the virtual subgroup, the messaging server 104 displays the message in the virtual subgroup displayed by the group communication interfaces of the user device 102 and the assistant device 104 and displays that the members of the virtual subgroup only include the user device 102 and assistant device 104 according to the group setting data.

In Step S04 of the embodiment, the message distribution module 1012 in the messaging server 101 will access the group setting data stored by the group management module 1013 in the foregoing manner, and then obtain the members included in the virtual subgroup according to the group setting data. The message distribution module 1012 then accesses the information (such as the IP addresses of the user device 102 and the assistant device 104) of the members in the member management module 1014. Finally, the message distribution module 1012 sends the message to the user device 102 and the assistant device 104 respectively through the transceiver module 1011 and the network and displays the message in the virtual group displayed by the group communication interfaces of the user device 102 and the assistant device 104. The members displayed by the virtual subgroup only include the user devices 102 and the assistant devices 104.

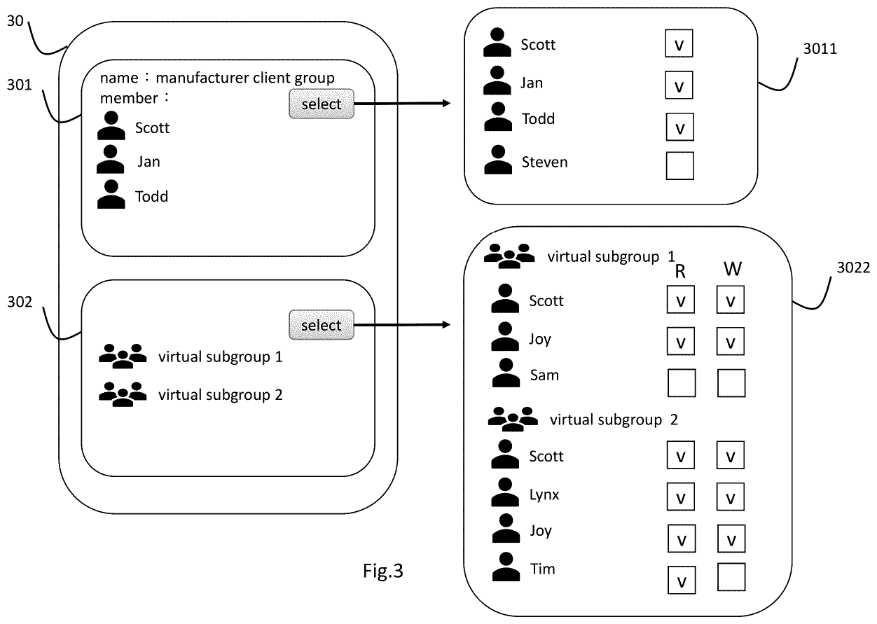

FIG. 3 is a schematic diagram illustrating group setting data edited by a user device according to a preferred embodiment of the present invention. As illustrated in FIG. 3, The user operates the user interface 30 of the user device 102 to display the area 301 of a workgroup and the area 302 of a virtual subgroup. The area 301 of the workgroup will display a selection button, the name of the workgroup (e.g., the name is manufacturer client group), and the members of the workgroup. The area 302 of the virtual subgroup will only display a selection button and the name of the virtual subgroup in order to simplify the content. However, in other embodiments of the present invention, the area 302 of the virtual subgroup can also display the name of the virtual subgroup and the members of each virtual subgroup.

On the right side of the area 301 of the workgroup in FIG. 3, it is displayed that when the user presses the selection button of the area 301 of the workgroup, a contact list 3011 will appear for the user to select the members added to the workgroup. On the right side of the area 302 of the virtual subgroup, it is displayed that when the user presses the selection button of the area 302 of the virtual subgroup, a group list 3022 will appear. In the group list 3022, several groups in which the user has been included and the members in these groups will be displayed, allowing the user to select and add the members of the virtual subgroup to the workgroup, and to set the message receiving/sending permission of each member. It should be understood that other embodiments of the present invention may have other presentation manners of the user interface.

In the embodiment, a workgroup including two virtual subgroups is displayed. The workgroup includes two client devices Jan and Todd and a user device Scott which constructed the workgroup. The virtual subgroup 1 includes the user device Scott and an assistant device Joy, but does not include the unselected assistant device Sam. The virtual subgroup 2 includes the user device Scott and assistant devices Lynx, Joy, and Tim, but the assistant device Tim only has the message receiving permission, not the message sending permission.

FIGS. 4A˜4F are schematic diagrams illustrating the group communication interfaces of devices of members according to a preferred embodiment of the present invention. FIG. 4A is a schematic diagram illustrating the group communication interface of the user device Scott. FIG. 4A shows two tabs of the workgroup and the virtual subgroup. If the user device Scott clicks on the tab of the workgroup, the group communication interface will further display the message content of the workgroup. If the user device Scott clicks on the tab of the virtual subgroup, the group communication interface will further display the text of the virtual subgroups 1 and 2 for the user device Scott to choose. If the user device Scott clicks on the virtual subgroup 2, the group communication interface will further display the message content of the virtual subgroup 2. It should be understood that, in the workgroup displayed by the group communication interface of the user device Scott, the message sent by the user device Scott himself will be marked as Scott. Messages sent by the assistant device (such as the assistant device Joy) instead of the user device Scott will be additionally marked (e.g., marked as Scott (Joy)), so that the user device Scott and the assistant device Joy can identify the sender of the message.

FIG. 4B is a schematic diagram illustrating the group communication interface of the assistant device Joy. Because the assistant device Joy is configured to have the permission to receive messages from the workgroup and to send messages to the workgroup, the group communication interface will display two tabs of the workgroup and the virtual subgroup. If the assistant device Joy clicks on the tab of the workgroup, the group communication interface will further display the message content of the workgroup. If the assistant device Joy clicks on the tab of the virtual subgroup, the group communication interface will further display the text of virtual subgroups 1 and 2 for the assistant device Joy to select (because the assistant device Joy included in the virtual subgroups 1 and 2). If the assistant device Joy clicks on the virtual subgroup 1, the group communication interface will further display the message content of virtual subgroup 1. If the assistant device Joy clicks on the virtual subgroup 2, the group communication interface will further display the message content of the virtual subgroup 2. Both the virtual subgroups 1 and 2 can send messages (the drawing may show a send button). The assistant device Joy has the permission to send messages to the workgroup (the drawing may show a send button). As a result, when the assistant device Joy sends a message in the workgroup, the workgroup of the client devices Jan and Todd will display that the message is sent by the user device Scott, so that the client devices Jan and Todd can believe that they are communicating with the familiar user device Scott to avoid causing trouble. In order to be able to identify the messages sent by the assistant device Joy instead of the user device Scott and the messages sent by the user device Scott himself, the message content of the workgroup displayed by the group communication interface of the assistant device Joy is additionally marked (e.g., marked as Scott (Joy)).

FIG. 4C is a schematic diagram illustrating the group communication interface of the assistant device Lynx. Because the assistant device Lynx is configured to have the permission to receive messages from the workgroup and to send messages to the workgroup, the group communication interface will display two tabs of the workgroup and the virtual subgroup. If the assistant device Lynx clicks on the tab of the workgroup, the group communication interface will further display the message content of the workgroup. If the assistant device Lynx clicks on the tab of the virtual subgroup, the group communication interface will directly display the message content of the virtual subgroup 2 (because the assistant device Lynx only included in the virtual subgroup 2). Similarly, if the assistant device Lynx sends a message in the workgroup (the drawing may show a send button), the workgroup displays that the message is sent by the user device Scott, so that the client devices Jan and Todd believe that they are communicating with the familiar user device Scott to avoid causing trouble. The assistant device Lynx can also send messages in the virtual subgroup 2 (the drawing may show a send button). Similarly, in order to identify the messages sent by the assistant device Lynx or the assistant device Joy instead of the user device Scott, and the messages sent by the user device Scott himself, the message content of the work group displayed by the group communication interface of the assistant device Lynx is additionally marked.

FIG. 4D is a schematic diagram illustrating the group communication interface of the assistant device Tim. Because the assistant device Tim is only configured to have the permission to receive messages from the workgroup, the group communication interface will display two tabs of the workgroup and virtual subgroups. If the assistant device Tim clicks on the tab of the workgroup, the group communication interface will further display the message content of the workgroup. If the assistant device Tim clicks on the tab of the virtual subgroup, the group communication interface will directly display the message content of the virtual subgroup 2 (because the assistant device Tim only included in the virtual subgroup 2). Since the assistant device Tim does not have the permission to send messages to the workgroup, the assistant device Tim cannot send messages to the workgroup (there is no send button in the drawing). However, the assistant device Tim can still send messages to participate in discussions among other members in the virtual subgroup 2, but the present invention is not limited thereto.

FIG. 4E is a schematic diagram illustrating the group communication interface of the assistant device Sam. Because the assistant device Sam does not be configured to have the permission to receive messages from the workgroup and to send messages to the workgroup, the group communication interface of the assistant device Sam does not display the tab of the workgroup. Accordingly, the group communication interface of the assistant device Sam only displays the message content of the virtual subgroup 1 in such a case (Because the assistant device Sam only included in the virtual subgroup 1). However, in the virtual subgroup 1, the assistant device Sam can still send messages to participate in discussions among other members, but the present invention is not limited thereto.

FIG. 4F is a schematic diagram illustrating the group communication interface of the assistant device Jan. As mentioned above, one of the objectives of the present invention is to make the users of the client devices in the workgroup not feel that too many members in the group cause trouble when contacting. Therefore, the assistant devices corresponding to the client devices in subgroups will be hidden. Based on the objective, in FIG. 4F, the group communication interface of the client device Jan will only display the message content of the workgroup. When the assistant device Joy or Lynx that has the permission to send messages to the workgroup sends messages to the workgroup, the workgroup of the client device Jan displays that the message is sent by the user device Scott but not additionally marked as the assistant devices Joy or Lynx. In this way, the client device Jan can believe that he is communicating with the familiar user device Scott to avoid causing trouble. The client device Jan can certainly send messages to communicate with the client device Todd and the user device Scott. Thus, the group communication interface displays a send button. It should be understood that the group communication interface of the client device Jan is used as an example in FIG. 4F. The operation of the group communication interface of the client device Todd is basically the same as that of the client device Jan.

According to the forgoing description, it is understood that the present invention provides a method of constructing community-oriented communication groups. In the method, a user can rapidly construct a new communication group and subgroups included in the new communication group according to requirements. Alternatively, the user combines two existing communication groups into a new communication group. In the new communication group constructed by the user, other members of the new communication group other than the user cannot detect some members of the subgroup. In this way, other members of the new communication group will not feel that too many members in the group cause trouble and some members in the subgroup will have the opportunity to help users reply to the messages in the new communication group.

Although various examples of the disclosed technology have been described above, it should be understood that these examples have been presented by examples rather than limited. Likewise, various drawings may depict example architectures or other configurations of the disclosed technology. The drawings may be depicted to assist in understanding the features and functionality that may be included in the disclosed technology. The disclosed technology is not limited to the illustrated example architectures or configurations, but the desired features can be implemented using a variety of alternative architectures and configurations. In fact, it will be obvious to those skilled in the art to know how to implement alternative functionalities, logical or physical partitions and configurations to implement the required features of the technology disclosed in this article. In addition, with regard to flowcharts, operation descriptions, and methodological technical solutions, the order in which the steps are presented herein should not require that the disclosed technologies be implemented in the same order to perform the listed functionality, unless the context dictates otherwise.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. A method of constructing community-oriented communication groups, applied to an environment comprising a messaging server, a user device, at least one client device, and at least one assistant device that are installed with software, wherein the user device, the at least one client device, and the at least one assistant device electrically connected to the messaging server, and the method of constructing community-oriented communication groups comprising:
Step (A): by a user, operating the user device to execute a group setting program to edit group setting data, wherein the group setting data includes a workgroup and a virtual subgroup included in the workgroup;
Step (B): sending the group setting data to the messaging server; and
Step (C): by the messaging server, respectively providing group communication interfaces for the user device, the at least one client device, and the at least one assistant device based on the group setting data, wherein the group communication interface of the at least one client device displays the workgroup, and the group communication interfaces of the user device and the at least one assistant device display one or a combination of the workgroup and the virtual subgroup.

2. The method of constructing community-oriented communication groups according to claim 1, wherein members of the workgroup include the user device and the at least one client device, and members of the virtual subgroup include the user device and the at least one assistant device.

3. The method of constructing community-oriented communication groups according to claim 2, wherein the group communication interface of the at least one client device displays the workgroup and members of the workgroup, the group communication interfaces of the user device and the at least one assistant device display the workgroup and members of the workgroup and display the virtual subgroup and members of the virtual subgroup.

4. The method of constructing community-oriented communication groups according to claim 1, wherein in Step (A), message receiving/sending permission of the assistant device is edited when executing the group setting program.

5. The method of constructing community-oriented communication groups according to claim 4, wherein the message receiving/sending permission of the assistant device includes: whether to receive messages from a workgroup and whether to send messages to a workgroup.

6. The method of constructing community-oriented communication groups according to claim 1, wherein in Step (A), a proxy authority of the assistant device is edited when executing the group setting program, wherein the proxy authority is set to display in a workgroup that a message is sent by the user device when the assistant device sends the message to a workgroup.

7. The method of constructing community-oriented communication groups according to claim 1, wherein in Step (A), the user selects two constructed groups as the workgroup and the virtual subgroup respectively when executing the group setting program.

8. The method of constructing community-oriented communication groups according to claim 1, further comprising Step (D): when the at least one client device sends a message to the workgroup, the messaging server displays the message in the workgroup displayed by the group communication interfaces of the at least one client device, the user device, and the at least one assistant device and displays that members of the workgroup only include the user device and the at least one client device according to the group setting data.

9. The method of constructing community-oriented communication groups according to claim 1, further comprising Step (D): when the at least one assistant device sends a message to the workgroup, the messaging server displays the message in the workgroup displayed by the group communication interfaces of the at least one client device, the user device, and the at least one assistant device and displays in a workgroup that the message is sent by the user device according to the group setting data.

10. The method of constructing community-oriented communication groups according to claim 1, further comprising Step (D): when the user device or the at least one assistant device sends a message to the virtual subgroup, the messaging server displays the message in the virtual subgroup displayed by the group communication interfaces of the user device and the at least one assistant device and displays that members of the virtual subgroup only include the user device and the at least one assistant device according to the group setting data.
